(19) United States
(12) Patent Application Publication
(10) Pub. No.: US 2026/0331330 A1
(43) Pub. Date: Oct. 22, 2026

(54) CONDUCTIVE CABLE AND METHOD FOR PRODUCING THE SAME

(71) Applicant: HAYASHI YARN TWISTING CO., LTD., Hashimoto-shi, Wakayama (JP)

(72) Inventor: Yuta HAYASHI, Wakayama (JP)

(21) Appl. No.: 19/103,463

(22) PCT Filed: Jul. 3, 2023
(86) PCT No.: PCT/JP2023/024688

§ 371 Date: Feb. 12, 2025

(30) Foreign Application Priority Data
Aug. 18, 2022 (JP) 2022-130587

(51) Int. Cl. H01B 7/00; H01B 13/00

(52) U.S. Cl. CPC H01B 7/00; H01B 13/0036

(57) ABSTRACT

A conductive cable includes a coiled electric wire 7 and a chain-stitched yarn 4, the chain-stitched yarn 4 being continuously chain-stitched, the coiled electric wire 7 being sewn under loops 3 of the chain stitched yarn 4, and the coiled electric wire 7 and the chain-stitched yarn 4 being integrated. A method for producing the conductive cable includes performing chain stitching using a chain stitch sewing machine so that the loops 3 of the chain stitched yarn 4 are continuously formed on one face of a sheet, and sewing the coiled electric wire 7 under the loops of the chain-stitched yarn when the chain stitching is performed. A core yarn may be further present inside the coil formed by the coiled electric wire 7. Thus, a conductive cable that conforms smoothly to fabrics, does not slacken unnecessarily, does not kink, and is easy to use is provided.

### TECHNICAL FIELD

The present invention relates to a conductive cable and a method for producing the same.

### BACKGROUND ART

The spiral shape of coiled cords that connect land line telephones and handsets is conventionally known to allow the coiled cords to conform to movements smoothly, preventing disconnection of conductive wires. Also, there are cables in which conductive wires or conductive fibers are spirally wound around an elastic core to reduce slack in the cables and improve ease of handling.

Spiral cables, however, have a problem in that their structure collapses when twisted in the opposite direction of their spiral, resulting in the tangling of the cables. In addition, cables with a spiral structure in which a conductive wire or a conductive fiber is wound around a core have a problem in that the core and the spiral structure may move out of position due to abrasion or expansion/contraction and separate from each other, resulting in disconnection, and, for this reason, these cables need to be processed to achieve ease of handling, by covering the outside of the spiral structure with resin, a tube, or a braid so as to cover the entire spiral structure and prevent the internal structure from being exposed. However, cables processed as described above have increased outer diameters and stiffer structures, which makes the cables difficult to bend or twist and have a reduced expansion/contraction ratio, causing a problem of hindering the conformance to movements.

Meanwhile, in so-called wearable clothing and the like in which an instrument for measuring blood pressure, pulse, etc. is incorporated, conductive yarns or conductive materials are used for electrically connecting the instrument for measuring blood pressure, pulse, etc. to a communication means for transmitting data from the instrument to the outside. Patent Document 1 proposes, as conductive yarns, a carbon-based conductive yarn, a plated yarn plated with metal or an alloy, a conductive resin fiber yarn, a metal fiber yarn, and the like. Patent Document 2 proposes a nylon yarn into which conductive carbon fine particles are kneaded. Patent Document 3 proposes a yarn that is obtained by slitting a metal vapor-deposition film obtained by depositing metal, such as gold or silver, on a surface of a polyester film. Patent Document 4 proposes a flexible electrode as an electrode to be used in wearable clothing.

### PRIOR ART DOCUMENTS

### Patent Document

[Patent Document 1] JP 2016-129115A

[Patent Document 2] JP 2017-201063A

[Patent Document 3] JP 2009-044439A

[Patent Document 4] JP 2015-139506A

### DISCLOSURE OF INVENTION

### Problem to be Solved by the Invention

However, conventional metal cables do not conform smoothly to fabrics and are not easy to use.

In order to solve the above-described conventional problems, the present invention provides a conductive cable that conforms smoothly to fabrics, does not slacken unnecessarily, does not kink, and is easy to use.

### Means for Solving Problem

A conductive cable of the present invention is characterized in that it includes a coiled electric wire and a chain-stitched yarn, the chain-stitched yarn being continuously chain-stitched, the conductive wire being sewn under loops of the chain-stitched yarn, and the conductive wire and the chain-stitched yarn being integrated.

A conductive cable production method of the present invention is characterized in that it includes performing chain stitching using a chain stitch sewing machine so that loops of a chain-stitched yarn are continuously formed on one face of a sheet, and sewing a conductive wire under the loops of the chain-stitched yarn to integrate the conductive wire with the chain-stitched yarn when the chain stitching is performed.

### Effects of the Invention

The conductive cable of the present invention includes the coiled electric wire and the chain-stitched yarn, the chain-stitched yarn being continuously chain-stitched, the coiled electric wire being sewn under the loops of the chain-stitched yarn, and the coiled electric wire and the chain-stitched yarn being integrated. Thus, the coiled electric wire conforms smoothly to a fabric, and the conductive cable does not slacken unnecessarily, does not kink, and is easy to use. The conductive cable production method of the present invention includes performing chain stitching using a chain stitch sewing machine so that loops of a chain-stitched yarn are continuously formed on one face of a sheet, and sewing a coiled electric wire under the loops of the chain-stitched yarn to integrate the coiled electric wire with the chain-stitched yarn when the chain stitching is performed. Thus, the conductive cable of the present invention can be produced efficiently.

### BRIEF DESCRIPTION OF DRAWINGS

FIG. 1 is a schematic diagram illustrating steps of producing a chain-stitched yarn chain-stitched onto a sheet, which is used in an embodiment of the present invention.

FIG. 2 is a schematic explanatory diagram showing the chain-stitched yarn.

FIG. 3 is a schematic explanatory diagram showing a coiled electric wire of the embodiment of the present invention sewn under the loops of the chain-stitched yarn and integrated with the chain-stitched yarn.

FIG. 4 is a schematic explanatory diagram showing a core yarn further placed inside the coil formed by the coiled electric wire of the embodiment of the present invention.

FIG. 5 is a side photograph showing a state in which a coiled electric wire is being sewn under the loops of a chain-stitched yarn when the chain-stitched yarn is being chain-stitched.

FIG. 6 is an enlarged side photograph of FIG. 5.

FIG. 7 is a side photograph showing a state in which a lower portion of a base sheet has been removed from the state shown in FIG. 6.

FIG. 8 is a side photograph showing a state in which the entire base sheet has been removed from the state shown in FIG. 7.

FIG. 9 is a side photograph showing a state in which a core yarn is further placed inside the coil formed by the coiled electric wire.

FIG. 10 is a side photograph showing a state in which half of a lower portion of a base sheet has been removed after chain stitching together with the base sheet was performed, and a core yarn was further placed inside the coil formed by the coiled electric wire.

FIG. 11 is a side photograph showing a state in which the entire base sheet has been removed from the state shown in FIG. 10.

FIG. 12 is a photograph showing a state in which the core and the chain stitch have been made to exhibit elasticity by performing heat treatment in the state shown in FIG. 11.

FIG. 13 is a plan photograph showing a state of a coiled portion (on a fabric front face) sewn onto a fabric.

FIG. 14 is a plan photograph showing a state of a chain-stitched portion (on a fabric back face) sewn onto the fabric.

FIG. 15 is a side photograph showing a state in which a cable has been separated from the fabric.

### DESCRIPTION OF THE INVENTION

The present invention relates to a conductive cable that includes a coiled electric wire and a chain-stitched yarn. A coiled electric wire is used, for example, as a coiled cord connected between the body of a land line telephone and a handset. The coiled electric wire of the present invention is not limited to a coiled cord, and may be thicker or thinner than a coiled cord. Also, any coil shape can be adopted. A chain stitch can be formed by chain stitching, which also encompasses chain stitching serving as the basis of warp knitting. The chain-stitched yarn is continuously chain-stitched, the conductive wire is sewn under the loops of the chain-stitched yarn, and the conductive wire and the chain-stitched yarn are integrated. Being “sewn under the loops of the chain-stitched yarn” means that the coiled electric wire is included and incorporated into the chain-stitched yarn structure. Thus, the coiled electric wire conforms smoothly to a fabric, and a conductive cable that does not slacken unnecessarily, does not kink, and is easy to use can be obtained.

Preferably, the coiled electric wire is continuously or intermittently sewn under the loops of the chain-stitched yarn at a ratio of one turn per 1 to 20 loops of the chain-stitched yarn. This makes it possible to control the properties of the coiled electric wire conforming to a fabric.

A core yarn may be further present inside the coil formed by the coiled electric wire. The core yarn preferably has a diameter of 0.01 to 20 mm. The core yarn is preferably an elastic yarn or a non-elastic yarn. When an elastic yarn is used as the core yarn, elasticity can be imparted to the conductive cable. This elasticity is controlled elasticity within a specific range, with the upper limit being the length of the chain-stitched yarn at its tensile limit and the lower limit being the length of the coil of the coiled electric wire at its compression limit. When the length of the coil of the coiled electric wire at the compression limit is taken as 100%, elongation within a range of 101% to 300% is generally possible. When a non-elastic yarn is used as the core yarn, the dimensional stability of the coiled electric wire can be enhanced, and the effect of reinforcing the coiled electric wire can be enhanced. Preferred materials for the elastic yarn include rubber, urethane, silicone, thermoplastic elastomers, conjugated multifilament yarns made of synthetic fibers, and the like. Materials similar to the material of the chain-stitched yarn, which will be described later, can also be used as the material of the core yarn.

It is preferable that the chain-stitched yarn is continuously chain-stitched onto a sheet (material for sewing). The sheet (material for sewing) may be paper, a resin sheet, a resin film, a woven fabric, a knitted fabric, a nonwoven fabric, or any other similar material. In the case of wearable clothing, the chain-stitched yarn may be sewn onto a fabric of clothing or a subsidiary material thereof (for example, a belt, a reinforcing cloth, a protective cloth, etc.). Alternatively, the conductive cable may be removed by tearing the sheet (material for sewing) along the chain-stitched yarn.

A conductive cable production method of the present invention includes performing chain stitching using a sewing machine so that loops of a chain-stitched yarn are continuously formed on one face of a sheet. An example of the sewing machine is a chenille embroidery machine sold by Tajima Industries Ltd. under the trade name TCMX series. However, it was the inventor of the present invention who conceived the ideas of sewing the coiled electric wire under the loops of the chain-stitched yarn to integrate the coiled electric wire with the chain-stitched yarn and further placing the core yarn inside the coil formed by the coiled electric wire.

For the chain-stitched yarn, for example, natural fibers, such as cotton, hemp, wool, and silk; synthetic fibers, such as polyester, nylon, acrylic, vinylon, polyolefin, para aramid, meta aramid, polyarylate, and polybenzoxazole; regenerated fibers, such as rayon; as well as rubber, urethane, silicone, and thermoplastic elastomers are preferable. A wire or yarn that is used when imparting conductivity to a chain-stitched portion may be made of a copper wire, an aluminum wire, a stainless steel wire, tungsten (W), molybdenum (Mo), a metal-plated fiber, or any other conductive material. The chain-stitched yarn may be a filament yarn or a spun yarn. As an example, a polyester conjugated multifilament yarn obtained by conjugate spinning different types of polyester, such as polyethylene terephthalate and polytetramethylene terephthalate, may be used. A commercially available example is “T400” (trade name) manufactured by Toray. In addition, a handicraft elastic cord obtained by covering a rubber thread with a braid can be used, or a braid, a twisted yarn, or other products can also be used. The chain-stitched yarn preferably has a diameter of 10 μm to 3 mm.

It is preferable that the chain-stitched yarn includes a high-melting point synthetic fiber yarn with a melting point of 200 °C or higher and a low-melting-point synthetic fiber yarn with a melting point of less than 200 °C, and the melting point synthetic fiber yarn is fused. In this case, misalignment of a coiled electric wire material caused by tension or abrasion that cannot be tolerated by the chain stitch structure alone can be prevented by melting a chain stitch material and bonding it to the core yarn and the fabric. An example of the high melting point synthetic fiber yarn is a polyethylene terephthalate multifilament yarn with a melting point of approximately 260 °C, and an example of the low melting-point synthetic fiber yarn is a copolymerized nylon yarn with a melting point of approximately 70 °C.

The coiled electric wire preferably has a diameter of 0.005 to 10 mm. The coil preferably has a diameter of 0.02 to 40 mm. The coiled electric wire may be made of a copper wire, an aluminum wire, a stainless steel wire, tungsten (W), molybdenum (Mo), a metal-plated fiber, or any other similar material. A bare electric wire or a coated electric wire can be used as the electric wire. In the case of a coated electric wire, the coating may be made of rubber, resin, fiber-reinforced rubber, fiber-reinforced resin, or any other coating material. The coiled electric wire material preferably has a straight shape. When a straight electric wire is sewn under the loops of the chain-stitched yarn and integrated with the chain-stitched yarn, the electric wire is fixed under the loops of the chain-stitched yarn at every predetermined distance (for example, 2 to 20 mm), with non-fixed portions of the electric wire remaining free, and hence the electric wire has a coiled shape. It is preferable to use a twisted pair cable obtained by twisting two coated electric wires together as the coiled electric wire material. The reason for this is that if electric wires for transmitting electric signals are parallel, and a magnetic field is generated by electromagnetic waves from airborne noise, an electromotive force is generated as a result of the magnetic field, and an induced current is generated and becomes a noise source. As a countermeasure for this, two or more electric wires are twisted together. Thus, each twist reverses the direction of the electromotive force, and the electromotive force cancels out the noise, so that the effect of airborne noise can be reduced. A coiled electric wire with good conforming properties and reduced noise can be obtained by using the above-described twisted electric wire as the coiled electric wire material.

It is also possible to use as the conductive wire a so-called elongated FPC, which is obtained by processing a substrate, called a flexible printed circuit board or flexible printed wiring board (FPC), into a narrow shape. The substrate is prepared by forming one or more electric circuits in a base material obtained by laminating a thin, soft, insulating base film, such as a polyimide film, and a conductive metal, such as a copper foil; a material obtained by processing a resin sheet or film on which a wiring pattern is printed using an electrically conductive ink into a narrow shape; or a strip of tape obtained by slitting a conductive foil, nonwoven fabric, paper, resin sheet, resin film, or the like into a narrow shape. These narrow-shaped conductive wires preferably have a width of 0.05 to 15 mm and a thickness of 0.01 to 3 mm.

When a bare conductive wire, such as a metal wire, a metal-plated fiber, or a narrow strip of conductive tape that does not have insulation coating, is used in a coiled portion, the present invention can be used as an electrode configured to come into contact with the skin of wearable clothing for measuring pulse or myoelectric potential, or of an electric stimulation therapy device. In addition, the coiled portion can be formed by winding a single bare conductive wire or by aligning multiple bare conductive wires parallel to one another and winding them simultaneously. When the bare conductive wire or wires are wound or sewn onto a fabric in such a manner that portions of the bare conductive wire or wires are in contact with each other, the number of electric paths increases, allowing the current to flow more easily. Furthermore, in addition to the coiled portion, when a metal wire, a metal-plated fiber, or the like that does not have insulation coating is used in the chain-stitched portion as well, portions of the bare conductive wires are in contact with each other, increasing the number of electric paths and hence facilitating the flow of current. When the bare conductive wires are sewn onto the fabric, the coiled portion is disposed on the front face of the fabric, and the chain stitch is disposed on the back face of the fabric, and therefore, an electric path from the front face to the back face can also be obtained. The resulting conductive cable may be used while remaining sewn onto the fabric, or may be used after being separated from the fabric by, for example, tearing or dissolving the fabric. For example, the coiled portion may be formed using a twisted yarn, or the coiled portion and the chain-stitched portion may be formed using a twisted yarn composed of a conductive metal wire or fiber and water-soluble vinylon, and after the conductive cable is produced, the water soluble vinylon may be dissolved and removed to expose conductive materials. In this manner, the number of contacts between the conductive materials can be increased to increase the number of electric paths.

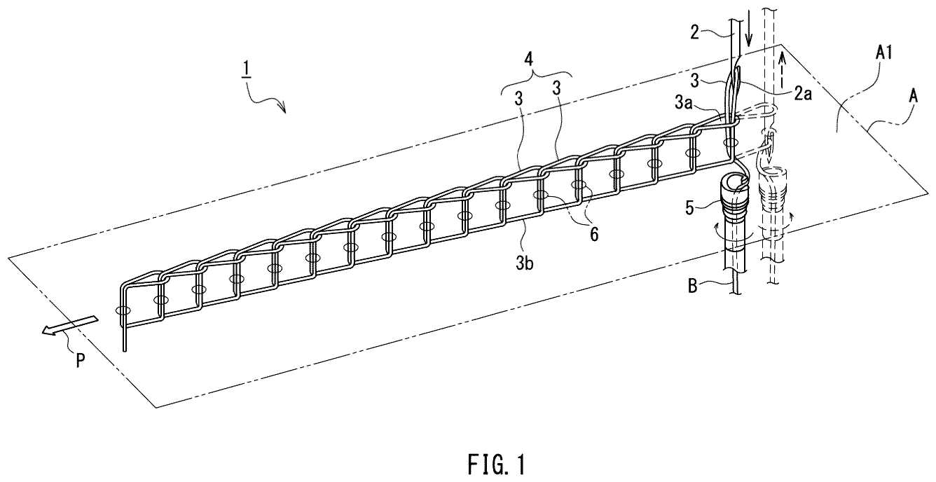

Hereinafter, descriptions will be given using the drawings. In the drawings referenced below, identical reference numerals denote identical components. FIG. 1 is a schematic diagram illustrating steps of producing a chain-stitched yarn 4 chain-stitched onto a sheet, which is used in an embodiment of the present invention. Reference numeral 1 denotes a chain stitching apparatus for forming the chain-stitched yarn 4. FIG. 1 shows a case where the orientation of a hook needle 2 and the orientation of a looper 5 are reversed 180 degrees with respect to a feed direction P. That is, the upper side and the lower side are reversed for convenience of description. In this case, because the orientation of a hook portion 2a of the hook needle 2 is opposite to the feed direction P of a sheet (material for sewing) A, even when the hook needle 2 reaches the uppermost point and switches to downward movement, a supplied yarn B moves together with the hook needle 2 while remaining engaged with the hook portion 2a of the hook needle 2, and a loop 3 is thus folded in a direction opposite to the feed direction P.

Then, when the hook needle 2 passes through the sheet (material for sewing) Ain a downward direction, the loop 3 comes off the hook portion 2a of the hook needle 2. At this time, the hook needle 2 is located within an inner portion 3a of the loop 3 of the supplied yarn B, and therefore, another loop 3 that is formed next as a result of the supplied yarn B being pulled up into an annular shape is pulled up through the inner portion 3a of the previous loop 3. By repeating this process, successive loops 3 are connected to form a chain shape, and thus, a chain-stitched yarn 4 is formed on an upper face Al of the sheet (material for sewing) A. The sheet (material for sewing) A is located between the loops 3 and yarn portions 3b on the back side, and needle holes 6 are formed. When the sheet (material for sewing) Ais paper, it is easy to tear the sheet A along the needle holes 6, allowing the sheet (material for sewing) A to be removed. In this manner, the chain-stitched yarn 4 can be isolated. In the case where a coiled electric wire, which will be described next, is sewn under the loops of the chain-stitched yarn to integrate the coiled electric wire with the chain-stitched yarn, or where a core yarn is further placed inside the coil formed by the coiled electric wire, the sheet (material for sewing) A can also be removed in the same manner.

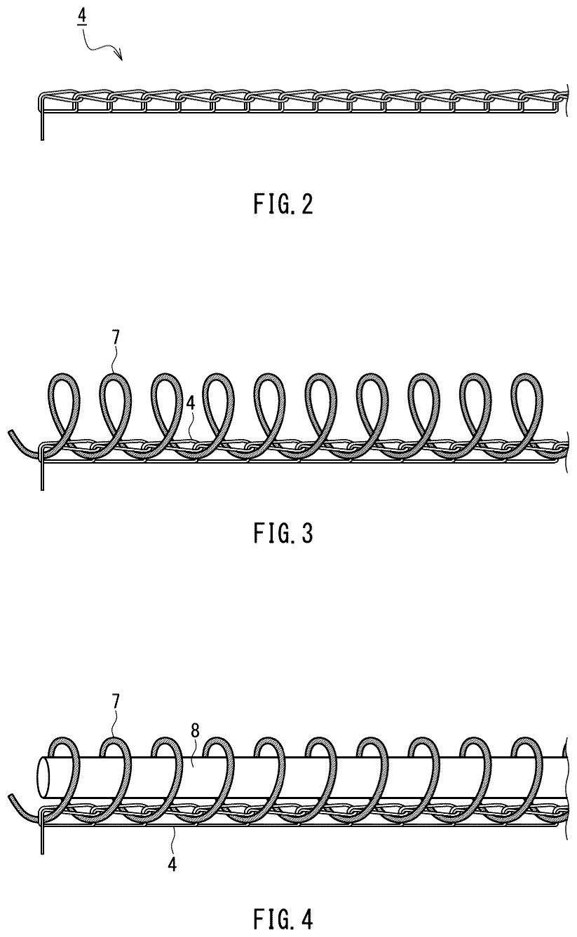

FIG. 2 is a schematic explanatory diagram showing the chain-stitched yarn 4 chain-stitched onto a sheet, which is used in the embodiment of the present invention.

FIG. 3 is a schematic explanatory diagram showing a coiled electric wire 7 of the embodiment of the present invention sewn under the loops of the chain-stitched yarn and integrated with the chain-stitched yarn 4.

FIG. 4 is a schematic explanatory diagram showing a core yarn 8 further placed inside the coil formed by the coiled electric wire 7 of the embodiment of the present invention and integrated with the chain-stitched yarn 4.

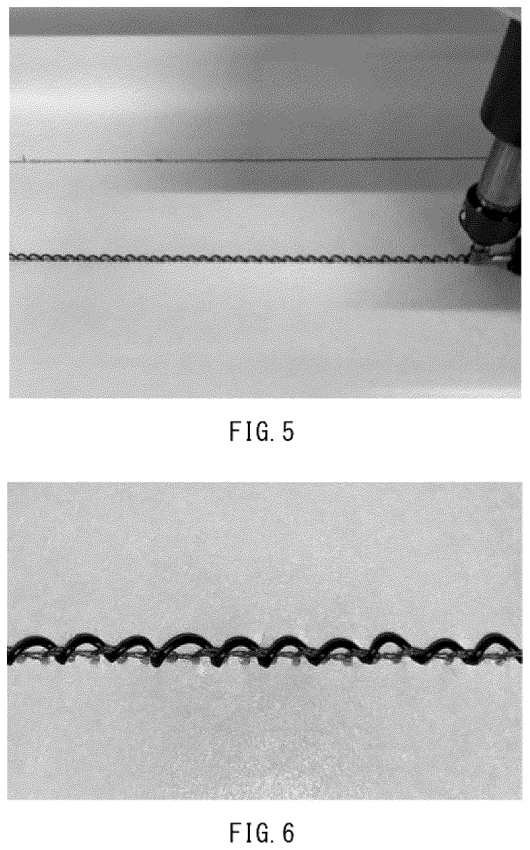

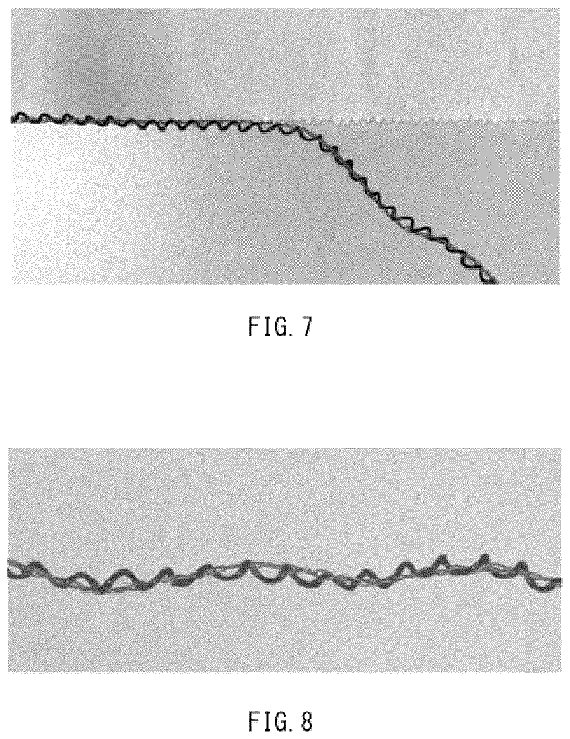

FIG. 5 is a side photograph showing a state in which a coiled electric wire is being sewn under the loops of a chain-stitched yarn when the chain-stitched yarn is being chain-stitched. In the photograph of FIG. 5, a jig for supplying a coated electric wire is shown at the right end. FIG. 6 is an enlarged side photograph of FIG. 5; FIG. 7 is a side photograph showing a state in which a lower portion of a base sheet has been removed along perforations from the state shown in FIG. 6; and FIG. 8 is a side photograph showing a state in which the entire base sheet has been removed along the perforations from the state shown in FIG. 7. In this manner, a cable in which the coated electric wire and the chain-stitched yarn are integrated is produced.

### EXAMPLES

The present invention will be described in further detail using examples below. However, the present invention should not be construed as being limited to the following examples.

In the following examples, a chenille embroidery machine sold by Tajima Industries Ltd. under the trade name TCMX-600 was used as a chain stitch sewing machine.

### Example 1

### (1) Chain-Stitched Yarn

As a chain-stitched yarn, a single strand of polyester conjugated multifilament yarn (trade name: “T400”, manufactured by Toray) with a total fineness of 330 decitex and a filament count of 68 (approximately 0.3 mm in diameter) was used.

### (2) Electric Wire

A coated electric wire constituted by seven conductors with a conductor diameter of 0.08 mm was used. The material of the conductors was a tin-plated copper wire. The coating resin was a vinyl chloride resin. The coated electric wire had an outer diameter of 0.65 mm.

### (3) Core Material

As a core material, ten strands of polyester conjugated multifilament yarn (trade name: “T400”, manufactured by Toray) with a total fineness of 330 decitex and a filament count of 68 were aligned parallel to one another and used.

### (4) Production of Conductive Cable

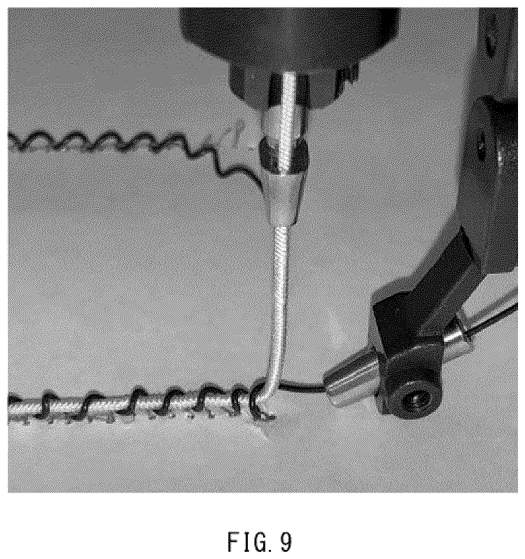

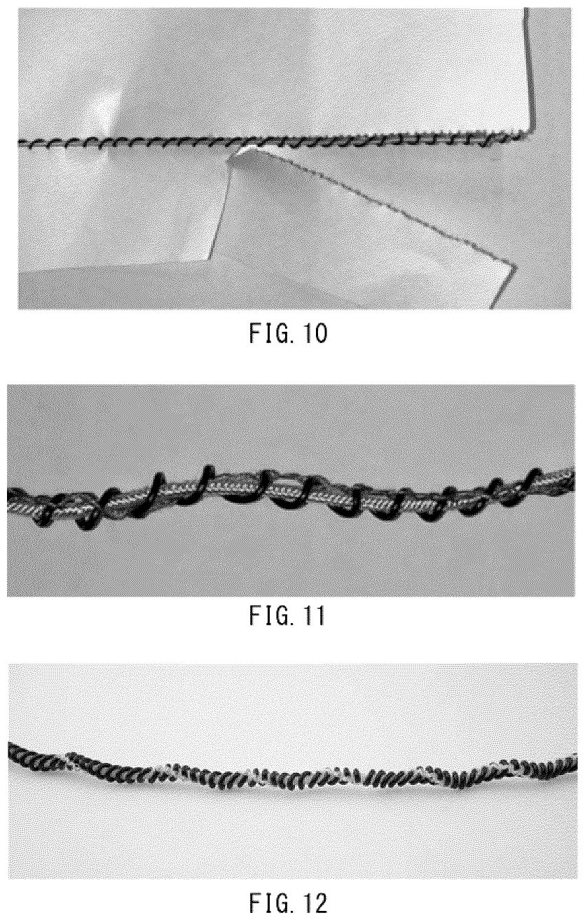

A 50 μm thick sheet of kraft paper was used as a base sheet. The core yarn was further placed inside the coil formed by the coiled electric wire as shown in FIG. 9, and integrated with the chain-stitched yarn. FIG. 10 is a side photograph showing a state in which half of a lower portion of the base sheet has been removed along perforations after performing chain stitching together with the base sheet and further placing the core yarn inside the coil formed by the coiled electric wire. FIG. 11 is a side photograph showing a state in which the entire base sheet has been removed along the perforations from the state shown in FIG. 10.

The resulting conductive cable was then heat-treated at 100 °C for 2 minutes to allow the polyester conjugated multifilament yarn (trade name: “T400”, manufactured by Toray), which was used as the chain-stitched yarn and the core material, to exhibit its elasticity. For heating, steam from an iron was used in the case of a wet heating method, and a heat gun was used in the case of a dry heating method. In this manner, the coil turns of the coated electric wire shrank through heating after production, and as a result, a cable with improved conforming properties due to an increased coil density per unit length was produced. FIG. 12 is a photograph showing a state in which the core and the chain stitch exhibit elasticity after the heat treatment.

The obtained conductive cable was suitable for wearable clothing.

### Example 2

### (1) Chain-Stitched Yarn

As a chain-stitched yarn, a yarn (approximately 0.2 mm in diameter) prepared in the following manner was used: 33 μm tungsten (uncoated) and a polyester (PET) multifilament yarn with a total fineness of 155 decitex and a filament count of 48 were used as a core, a polyester (PET) multifilament yarn with a total fineness of 83 decitex and a filament count of 36 was used as a sheath, and covering twisting was performed such that the tungsten was exposed.

### (2) Electric Wire

As an electric wire, a yarn prepared in the following manner was used: 33 μm tungsten (uncoated) and a polyester (PET) multifilament yarn with a total fineness of 165 decitex and a filament count of 48 were used as a core, a polyester (PET) multifilament yarn with a total fineness of 83 decitex and a filament count of 36 was used as a sheath, and covering twisting was performed such that the tungsten was exposed.

### (3) Core Material

As a core material, a silicone tube (inner diameter: 0.5 mm, outer diameter: 1 mm) was used.

### (4) Production of Conductive Cable

As a fabric for sewing, a polyester felt fabric was used. The resulting conductive cable may be used while remaining sewn onto the fabric, or may be used after being separated from the fabric by, for example, tearing or dissolving the fabric.

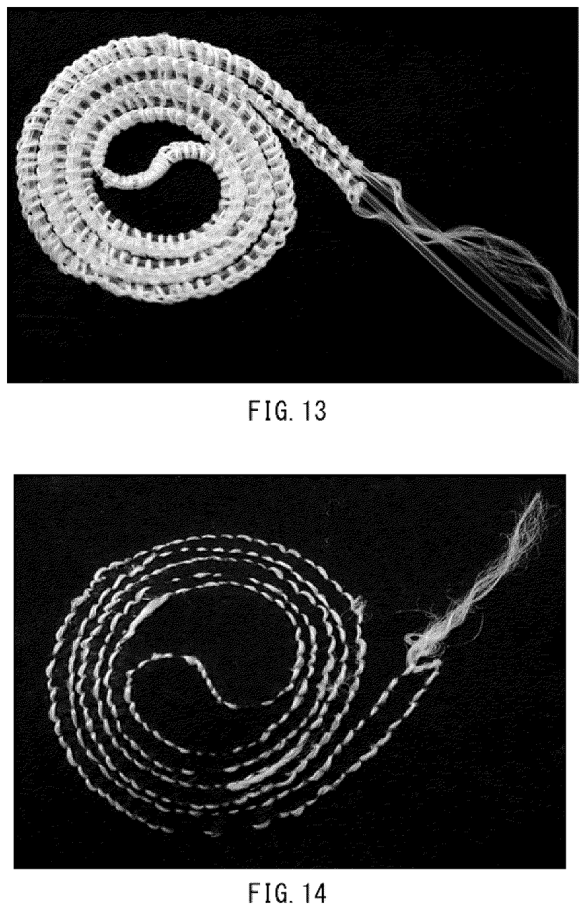

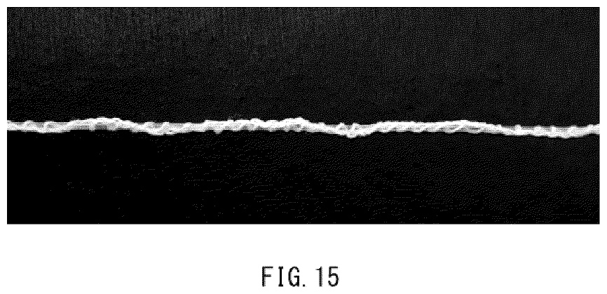

FIG. 13 is a plan photograph showing a state of a coiled portion (on the fabric front face) sewn onto the fabric; FIG. 14 is a plan photograph showing a state of a chain-stitched portion (on the fabric back face) sewn onto the fabric; and FIG. 15 is a side photograph showing the cable separated from the fabric, where there is no longer a distinction between the front side and the back side, and the coiled portion and the chain-stitched portion intersecting each other can be observed on the surface of the core.

The obtained conductive cable was suitable for wearable clothing.

The bare conductive wire, that is, the metal wire without insulation coating, was used in the coiled portion. Therefore, the conductive cable of the present example can be used as an electrode configured to come into contact with the skin of wearable clothing for measuring pulse or myoelectric potential, or as an electric stimulation therapy device. Moreover, the coiled portion can be formed by winding a single bare conductive wire or by aligning multiple bare conductive wires parallel to one another and winding them simultaneously. When the bare conductive wire or wires are wound or sewn onto a fabric in such a manner that portions of the bare conductive wire or wires are in contact with each other, the number of electric paths increases, allowing the current to flow more easily. Furthermore, in addition to the coiled portion, the chain-stitched portion was also formed using the bare wire, that is, the metal wire without insulation coating, which enables portions of the bare conductive wires to be in contact with each other, increasing the number of electric paths and hence facilitating the flow of current. When sewn onto the fabric, the coiled portion was disposed on the front face of the fabric, and the chain stitch was disposed on the back face of the fabric. This structure provides an electric path from the front face to the back face. The resulting conductive cable may be used while remaining sewn onto the fabric, or may be used after being separated from the fabric by, for example, tearing or dissolving the fabric.

### Example 3

### (1) Chain-Stitched Yarn

As a chain-stitched yarn, a single strand of polyester conjugated yarn (trade name: “T400”, manufactured by Toray) with a total fineness of 330 decitex and a filament count of 68 was used.

### (2) Electric Wire

As a coiled electric wire, a twisted pair cable obtained by twisting two coated electric wires together was used. This twisted pair cable was obtained by twisting the two coated electric wires together, each coated electric wire having an outer diameter of 0.65 mm and including seven conductors with a conductor diameter of 0.08 mm, with the material of the conductors being a tin-plated copper wire, and the coating resin being a vinyl chloride resin.

### (3) Core Material

As a core material, a yarn obtained by aligning nine strands of polyester conjugated yarn (trade name: “T400”, manufactured by Toray) with a total fineness of 330 decitex and a filament count of 68 parallel to one another was used.

### (4) Production of Conductive Cable

As a sheet for sewing, paper was used, and the sheet of paper was torn off after sewing. A 50 μm thick sheet of kraft paper was used as this sheet of paper, and the aforementioned twisted electric wire was chain-stitched together with this base sheet so as to be formed into a coiled electric wire. The core yarn was further placed inside the coil. After that, the entire sheet of paper was removed along the perforations, and the resulting conductive cable was then heat-treated at 100 °C for 2 minutes to allow the polyester conjugated multifilament yarn, which was used as the chain-stitched yarn and the core material, to exhibit its elasticity.

The obtained conductive cable was constituted by a coiled electric wire with good conforming properties and reduced noise, and was suitable for wearable clothing.

### Example 4

### (1) Chain-Stitched Yarn

As a chain-stitched yarn, a covering twisted yarn was used. The yarn had a structure in which a single strand of polyester (PET) multifilament yarn with a total fineness of 165 decitex and a filament count of 48 and a single strand of low melting-point nylon (melting point or softening point: 70 °C) with a total fineness of 110 decitex and a filament count of 12 were arranged as a core, and a single strand of low-melting-point nylon (melting point or softening point: 70 °C) with a total fineness of 110 decitex and a filament count of 12 was arranged as a sheath.

### (2) Electric Wire

As a coiled electric wire, a yarn prepared in the following manner was used: four 11-μm diameter strands (uncoated) of tungsten were used as a core, a single strand of water-soluble vinylon yarn of 132 decitex was used as a sheath, and covering twisting was performed such that the tungsten was exposed.

### (3) Core Material

As a core material, a yarn obtained by aligning six strands of polyester conjugated yarn (trade name: “T400”, manufactured by Toray) with a total fineness of 330 decitex and a filament count of 68 parallel to one another was used.

### (4) Production of Conductive Cable

As a sheet for sewing, a nonwoven fabric made of polyester fibers with a thickness of 100 μm and a mass (basis weight) of 20 g/m 2 was used. The covering-twisted yarn serving as the electric wire was chain-stitched together with the nonwoven fabric, and the core yarn was further placed inside the coil formed by the coiled electric wire. This was followed by dipping in hot water at 100 °C, to dissolve the water-soluble vinylon of the coiled yarn, to allow the polyester conjugated yarn to exhibit its elasticity, and to melt the low melting-point nylon of the chain stitch. Subsequently, the nonwoven fabric was torn along the perforations and removed.

In the obtained conductive cable, misalignment of the coiled electric wire material caused by tension or abrasion that cannot be tolerated by the chain stitch structure alone was prevented by the chain stitch material being melted and bonded to the core yarn and the fabric. Thus, the conductive cable was suitable for wearable clothing.

### INDUSTRIAL APPLICABILITY

The conductive cable according to the present invention is suitable for wearable clothing and subsidiary materials thereof (e.g., a belt, a reinforcing cloth, a protective cloth, and the like), cables for robots, telephone cords, medical instruments, logistics machinery, and other electrical and electronic devices.

### DESCRIPTION OF REFERENCE NUMERALS

1 Chain stitching apparatus
2 Hook needle
2a Hook portion
3 Loop
3a Inner portion of loop
3b Yarn portion on back side of loop
4 Chain-stitched yarn
5 Looper
6 Needle hole
7 Coiled electric wire
8 Core yarn
A Sheet (Material for sewing)
A1 Upper face of sheet (material for sewing)
P Feed direction of sheet (material for sewing)

1. A conductive cable comprising:
a coiled electric wire; and
a chain-stitched yarn,
wherein the chain-stitched yarn is continuously chain-stitched,
the coiled electric wire is sewn under loops of the chain-stitched yarn, and the coiled electric wire and the chain-stitched yarn are integrated, and
a core yarn further is present inside a coil formed by the coiled electric wire.

2. The conductive cable according to claim 1, wherein the coiled electric wire is continuously or intermittently sewn under the loops of the chain-stitched yarn at a ratio of one turn per 1 to 20 loops of the chain-stitched yarn.

3. (canceled)

4. The conductive cable according to claim 1, wherein the core yarn is an elastic yarn or a non-elastic yarn.

5. The conductive cable according to claim 1, wherein the chain-stitched yarn is continuously chain-stitched onto a sheet.

6. The conductive cable according to claim 5, wherein the sheet is at least one selected from the group consisting of paper, a resin sheet, a resin film, a woven fabric, a knitted fabric, and a nonwoven fabric.

7. The conductive cable according to claim 1, wherein the coiled electric wire is at least one selected from the group consisting of a twisted pair cable formed by twisting two coated electric wires together and a narrow strip of tape containing a conductive material.

8. The conductive cable according to claim 1, wherein the chain-stitched yarn includes a high-melting-point synthetic fiber yarn with a melting point of 200 °C or higher and a low-melting-point synthetic fiber yarn with a melting point of less than 200 °C, and the melting-point synthetic fiber yarn is fused.

9. The conductive cable according to claim 1, wherein the conductive cable comprises a core yarn and a chain-stitched yarn, and at least one yarn selected from the group consisting of the core yarn and the chain-stitched yarn is a conjugated multifilament yarn.

10. A conductive cable production method for producing a conductive cable including a coiled electric wire and a chain-stitched yarn, the chain-stitched yarn being continuously chain-stitched, the coiled electric wire being sewn under loops of the chain-stitched yarn, the coiled electric wire and the chain-stitched yarn being integrated, and a core yarn being further present inside a coil formed by the coiled electric wire, the method comprising:
performing chain stitching using a chain stitch sewing machine so that loops of a chain-stitched yarn are continuously formed on one face of a sheet; and
sewing a coiled electric wire under the loops of the chain-stitched yarn to integrate the coiled electric wire with the chain-stitched yarn and further placing a core yarn inside a coil formed by the coiled electric wire when the chain stitching is performed.

11. (canceled)

12. The conductive cable production method according to claim 10, comprising:
removing the sheet by tearing the sheet along the chain-stitched yarn after sewing the coiled electric wire under the loops of the chain-stitched yarn to integrate the coiled electric wire with the chain-stitched yarn.

13. The conductive cable production method according to claim 10, wherein the core yarn is an elastic yarn or a non-elastic yarn.

14. The conductive cable production method according to claim 10, wherein the chain-stitched yarn is continuously chain-stitched onto the sheet.

15. The conductive cable production method according to claim 14, wherein the sheet is at least one selected from the group consisting of paper, a resin sheet, a resin film, a woven fabric, a knitted fabric, and a nonwoven fabric.

16. The conductive cable production method according to claim 10, wherein the coiled electric wire is at least one selected from the group consisting of a twisted pair cable formed by twisting two coated electric wires together and a narrow strip of tape containing a conductive material.

17. The conductive cable production method according to claim 10, wherein the chain-stitched yarn includes a high-melting-point synthetic fiber yarn with a melting point of 200 °C or higher and a low-melting-point synthetic fiber yarn with a melting point of less than 200 °C, and the low-melting-point synthetic fiber yarn is fused.

18. The conductive cable production method according to claim 10, wherein the conductive cable comprises a core yarn and a chain-stitched yarn, and at least one yarn selected from the group consisting of the core yarn and the chain-stitched yarn is a conjugated multifilament yarn.
